(19) United States
(12) Patent Application Publication
(10) Pub. No.: US 2026/0245127 A1
(43) Pub. Date: Aug. 20, 2026

(54) MANUFACTURING SYSTEM FOR MANUFACTURING ARTICLES OF CLOTHING AND OTHER GOODS

(71) Applicant: DXM, Inc., Greenwich, CT (US)

(72) Inventors: Matthew Wallace, Greenwich, CT (US); Joshua Boddiford, Wesley Chapel, FL (US); Jeffrey Sluder, Raleigh, NC (US)

(21) Appl. No.: 18/877,790

(22) PCT Filed: Jun. 21, 2022
(86) PCT No.: PCT/US2022/034312

§ 371 Date: Dec. 20, 2024

(51) Int. Cl. G06Q 30/0601

(52) U.S. Cl. CPC G06Q 30/06212

(57) ABSTRACT

According to embodiments of the present disclosure, a system for manufacture of articles of clothing and other goods is disclosed. The system includes receiving user and product characteristics from the user, such as body metrics for the user. The system includes presenting a customized visual representation of a clothing product to the user based on the body metrics of the user and/or predicted body measurements of the user. The system includes generating manufacturing instructions, including digital assets describing, for instance, pattern, size, stitching, and other manufacturing specification. The system includes manufacturing machines for manufacturing an article of clothing according to the manufacturing specification. In some embodiments, the system may be used to manufacture small lots of clothing, including single items of clothing.

### TECHNICAL FIELD

The present disclosure relates to manufacturing systems and methods for manufacturing articles of clothing and other goods.

### BACKGROUND

Machines for the manufacture of clothing and other goods are known. These machines can include cutting machines, embroidery machines, digital printing machines, sublimation printing machines, direct to fabric printing machines, and direct to garment printing machines. Such machines are typically used for manufacturing of large lots of articles of clothing. For example, a clothing manufacturer may receive an order to manufacture a run of 10,000 articles of a specific shirt product or pants product. The manufacturing machines are then used, alone or in combination, to manufacture that run of clothing articles.

### SUMMARY

According to embodiments of the present disclosure, a system is disclosed. The system may be used for manufacturing of articles of clothing or other goods.

The system may include a user equipment configured to receive user input including user characteristic information and product characteristic information. The user characteristic information includes a plurality of body metrics for the user, a body scan, and/or user avatar parameters. The product characteristic information includes product identifying information for an item of interest for the user.

The system may include a product presentation system configured to present product configurations to the user. The product presentation system is further configured to receive a product selection from the user equipment, wherein the product selection comprises order line item details and a recipe specification. The order line item details include order identifying information. The recipe specification includes identification of a clothing product and one or more of clothing size information or clothing fit information.

The system may include a manufacturing control system configured to provide, based on the user characteristic information and the product characteristic information, the product configurations to the product presentation system. The product configurations include one or more configuration for a clothing product corresponding to the item of interest for the user. The manufacturing control system is configured to retrieve the order line item details and the recipe specification from the product presentation system. The manufacturing control system is configured to determine a manufacturing specification for manufacture of an article of clothing corresponding to the product selection. The manufacturing control system is configured to determine a manufacturing format for one or more manufacturing machines. The manufacturing control system is configured to generate manufacturing instructions based on the manufacturing specification and the manufacturing format. The manufacturing control system is configured to transmit the manufacturing instructions to a manufacturing system.

The system may include a manufacturing system configured to receive the manufacturing instructions from the manufacturing control system. The manufacturing system is configured to provide the manufacturing instructions to the one or more manufacturing machines.

The system may include one or more manufacturing machines configured to manufacture the article of clothing corresponding to the product selection based on the manufacturing instructions.

The system may include a feature prediction system configured to predict one or more predicted features based at least in part on the user characteristic information or product characteristic information. The one or more predicted features includes one or more predicted body measurements of the user predicted based at least in part on the plurality of body metrics for the user, a body scan, and/or user avatar parameters.

The system may include a product configurator system configured to generate customized product configuration information based at least in part on the user characteristic information or product characteristic information and further based at least in part on the predicted features. The customized product configuration information includes a visual product rendering of a clothing product corresponding to the item of interest for the user generated based at least in part on the one or more predicted body measurements of the user, the user body scan, and/or the user avatar parameters. The product presentation system is configured to present the product configurations to the user based at least in part on the customized product configuration information.

The system may include a digital asset system configured to generate one or more manufacturing digital assets for manufacture of the article of clothing, a pair of shoes, a handbag, or other goods. The one or more manufacturing digital assets includes one or more of technical pack information or textile pattern images. The digital asset system is configured to receive the recipe specification from the manufacturing control system. The digital asset system is configured to generate the one or more manufacturing digital assets based at least in part on the recipe specification. The manufacturing control system is configured to determine the manufacturing specification based at least in part on the manufacturing digital assets.

The system may include a logistics system configured to cause the physical transport of the manufactured article of clothing from the one or more manufacturing machines to the user. The manufacturing control system is configured to select the one or more manufacturing machines for manufacture of the article of clothing based at least in part on a logistics specification provided by the logistics system. The manufacturing control system is configured to select the one or more manufacturing machines for manufacture of the article of clothing based at least in part on a comparison of manufacturing geographic location information provided in the logistics specification with a user geographic location information for the user.

In some embodiments of the system, the manufacturing control system is configured to generate the manufacturing instructions in a format that is machine-readable by the one or more manufacturing machines configured to manufacture the article of clothing corresponding to the product selection.

In some embodiments of the system, the visual product rendering of the clothing product includes a simulated three-dimensional rendering or a simulated two-dimensional rendering of an article of clothing with dimensions of the article of clothing adjusted to correspond to the one or more predicted body measurements of the user.

In some embodiments of the system, the manufacturing instructions include one or more of pattern information or stitching information.

In some embodiments of the system, the one or more manufacturing machines includes one or more of a cutting machine, a sewing machine, an embroidery machine, or a fabric printer.

In some embodiments of the system, the manufacturing instructions identify a manufacturing work order for less than ten articles of the article of clothing.

In some embodiments of the system, the manufacturing instructions identify a manufacturing work order for one article of the article of clothing.

According to embodiments of the present disclosure, corresponding systems, apparatuses, and machine-readable media are also provided.

### BRIEF DESCRIPTION OF THE DRAWINGS

FIG. 1 is a diagram of a system for manufacturing of articles of clothing or other goods.

FIG. 2 is a diagram of an apparatus for use in a system for manufacturing of articles of clothing or other goods.

FIG. 3 is a sequence diagram of a process for manufacturing of articles of clothing or other goods.

FIG. 4 is a sequence diagram of a process for manufacturing of articles of clothing or other goods.

FIG. 5 is a sequence diagram of a process for manufacturing of articles of clothing or other goods.

FIG. 6 is a sequence diagram of a process for manufacturing of articles of clothing or other goods.

FIG. 7 is a flowchart diagram of a process for manufacturing of articles of clothing or other goods.

### DETAILED DESCRIPTION

Machines for the manufacture of clothing and other goods are known. These machines can include cutting machines, sewing machines, 3D knitting machines, embroidery machines, digital printing machines, sublimation printing machines, direct to fabric printing machines, and direct to garment printing machines. Such machines are typically used for manufacturing of large lots of articles of clothing. For example, a clothing manufacturer may receive an order to manufacture a run of 10,000 articles of a specific shirt product or pants product. The manufacturing machines are then used, alone or in combination, to manufacture that run of clothing articles.

However, state of the art device communication and control systems generally do not support operation of such manufacturing machines in smaller manufacturing lots. This has resulted in considerable waste in the manufacturing industry, especially in clothing manufacturing. For instance, entire retail segments have been created to vend over-produced, off-season, and other unsold clothing, in the form of discount and deep discount retailers. This excess manufacturing is inefficient in use of resources (e.g., fabrics and cloths used for manufacturing) and in terms of allocation of manufacturing resources (e.g., allocation of manufacturing time for large manufacturing machines). While the clothing manufacturing industry has adapted to this inefficient process and its characteristic of overproduction, the present disclosure aims to provide the necessary communications and control systems to provide for improved manufacturing systems and processes that do not have these inefficiencies.

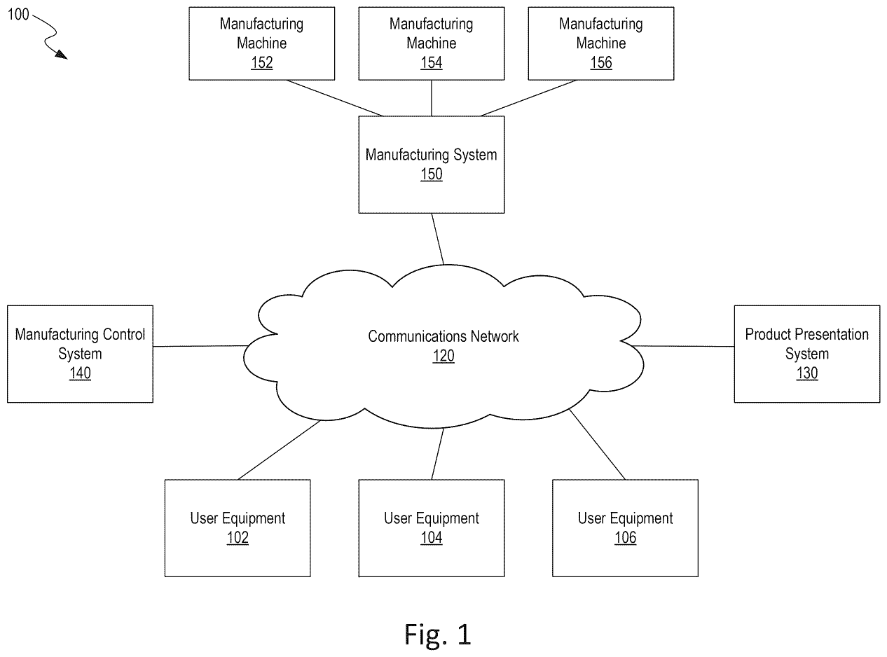

FIG. 1 is a diagram of a system 100 for manufacturing of articles of clothing or other goods. The system 100 includes user equipment 102, user equipment 104, user equipment 106, communications network 120, product presentation system 130, manufacturing control system 140, manufacturing system 150, manufacturing machine 152, manufacturing machine 154, and manufacturing system 156.

The user equipment 102, 104, and 106 may be computing devices or other apparatus operated by a user. For example, user equipment 102, 104, and 106 may include mobile computing devices (e.g., smart watch, smartphone, tablet computer, laptop computer). As further example, user equipment 102, 104, and 106 may include personal computers (e.g., laptop computers, desktop computers). As further example, user equipment 102, 104, and 106 may include other computing devices (e.g., kiosks, servers). The user equipment 102, 104, and 106 may provide an interface with which the user may interact with information and presentations provided by other components of the system 100. In some embodiments, the user may use the user equipment 102, 104, and 106 to provide various input (e.g., user characteristic information, body metrics of the user, body scan, user avatar parameters, product characteristic information, identification of an item of interest for the user).

The communications network 120 may be a communications network capable of facilitating communications between the components of the system 100. For example, the communication network 120 may include a telecommunications network (e.g., a local area network, an IEEE 802.11 Wi-Fi network, a wide area network, a 4G cellular network, a 5G cellular network, a Bluetooth link, a mesh network). In some embodiments, communications network 120 may be provided as more than one communications network (e.g., an IEEE 802.11 Wi-Fi network in combination with the Internet). The communications network 120 may provide an interface between the components of the system 100 so that the various components of the system 100 can transmit and receive information between one another.

The product presentation system 130 may be a system, apparatus, or device for presenting product information to a user. For example, the product presentation system 100 may include one or more computing devices operating computer software capable of transmitting webpage content to user equipment 102, 104, and 106 (e.g., web server, e-commerce server, application server). In some embodiments, the product presentation system 130 may provide presentation content to user equipment 102, 104, and 106 for presenting product configurations to the user. For example, the product configurations may include various customizations of a product available to the user (e.g., different sizes of an article of clothing, different colors of an article of clothing, different patterns of an article of clothing.

In some embodiments, the product presentation system 130 may provide product presentation information to the user equipment 102, 104, 106 in order to present product configurations in the form of a visual representation of products such as articles of clothing available to the user. For example, the product presentation system 130 may provide presentation content to user equipment 102, 104, and 106 so that an article of clothing (e.g., a shirt, shorts, pants) can be displayed with a visual product rendering on the user equipment 102, 104, and 106. The visual product rendering may be provided in various forms (e.g., two-dimensional illustration of the product, simulated three-dimensional rendering of the product, actual image of the product, video of the product).

In some embodiments, the product presentation system 130 may receive a product selection from the user equipment 102, 104, 106. The user equipment 102, 104, 106 may transmit the production selection to the product presentation system 130 based at least in part on receiving the product characteristic information from the user. The product selection may include identification of a specific product that is of interest to the user (e.g., a specific shirt, a specific pair of shorts, a specific pair of pants). The production selection may include further information related to the user and/or the product that is of interest to the user.

In some embodiments, the product selection may include order line item details. Order line item details may include information identifying a specific order initiated by the user. For example, the order line item details may include order identifying information, such as an order number, a vendor identifier, a timestamp for the order, etc. As further example, the order line item details may include further information, such as a quantity of an article ordered, a shipping address for the user, a name of the user, etc. The product presentation system 130 may persist one, some, or all of the information included in the order line item details (e.g., in a database maintained by the product presentation system 130, in a database maintained by the manufacturing control system 140, and/or in a database maintained by another component or system).

In some embodiments, the production selection may include a manufacturing recipe specification. The manufacturing recipe specification may include information identifying features of the item of interest selected by the user as part of the order identified by the order line item details. For example, when the item of interest is an article of clothing (e.g., shirt, shorts, pants), the manufacturing recipe specification may include identification various customizations of the article of clothing, such as a size of the article of clothing (e.g., small, medium, large, extra-large), a fit or cut of the article of clothing (e.g., regular fit, slim fit, tapered, straight leg), measurements for the article of clothing (e.g., inseam, collar, sleeve), a pattern of the article of clothing (e.g., checkered, flannel, solid), a material for the article of clothing (e.g., 100% cotton, 50/50, tweed, wool, corduroy), a color of the article of clothing (e.g., black, navy, red, white), etc.

The manufacturing control system 140 may be a system configured to control the manufacture of articles of clothing and other goods. In some embodiments, the manufacturing control system 140 may manage communications between other components of the system 100 in order to control manufacture of an article by the manufacturing machines 152, 154, 156. In some embodiments, the manufacturing control system 140 may be implemented using one or more computing devices (e.g., computers, servers, microcontrollers, device controller logic). The manufacturing control system 140 may be implemented in a single device (e.g., a server) or multiple devices (e.g., the combination of an application server, an on-site management server in a manufacturing plant, and a plurality of microcontrollers installed in one or more of the manufacturing machines 152, 154, 156) in various embodiments. The manufacturing control system 140 may be implemented with one or more sub-systems, one or more distributed systems, one or more independent computing systems, or in other ways in various embodiments.

In some embodiments, the manufacturing control system 140 may provide the product configurations to the product presentation system 130. For example, the manufacturing control system 140 may provide information specifying one or more sets of valid configurations of a particular product, such as available sizes for the article of clothing (e.g., small, medium, large, extra-large), available fits or cuts of the article of clothing (e.g., regular fit, slim fit, tapered, straight leg), available measurements for the article of clothing (e.g., maximum inseam, minimum inseam, maximum collar, minimum collar, maximum sleeve, minimum sleeve), available patterns of the article of clothing (e.g., checkered, flannel, solid), available materials for the article of clothing (e.g., 100% cotton, 50/50, tweed, wool, corduroy), available colors of the article of clothing (e.g., black, navy, red, white), etc.

In some embodiments, the product configurations provided by the manufacturing control system 140 to the product presentation system 130 may be based at least in part on user characteristic information and/or product characteristic information received by the user equipment 102, 104, 106 from the user. For example, the manufacturing control system 140 may generate the product configurations based on the plurality of body metrics for the user, the body scan, and/or user avatar parameters (e.g., providing an image of an article of clothing with the appropriate size for the user, providing a visual rendering of an article of clothing with the appropriate size for the user, providing a visual rendering of an article of clothing as presented on the avatar for the user defined by the user avatar parameters). As further example, the manufacturing control system 140 may generate the product configurations for a specific item of interest (e.g., specific shirt, specific short, specific pants) identified in the product characteristic information.

In some embodiments, the manufacturing control system 140 may retrieve the order line item details and/or the recipe specification from the product presentation system 130. For example, the product presentation system 130 may transmit the order line item details to the manufacturing control system 140 based upon receipt of an order for manufacturing of a product by the user using the user equipment 102, 104, 106. As further example, the product presentation system 130 may transmit the recipe specification to the manufacturing control system 140 upon receipt of an order for manufacturing of a product by the user using the user equipment 102, 104, 106.

In some embodiments, the manufacturing control system 140 may determine a manufacturing specification for manufacture of an article of clothing correspond to the product specification. For example, the manufacturing control system 140 may generate information specifying how an article of clothing is to be manufactured, such as based on the information contained in the order line item details and/or the recipe specification. In some embodiments, the manufacturing control system 140 may generate one or more digital assets as part of the manufacturing specification (e.g., textile pattern images, technical pack details, uniform resource locator for download of digital assets). In some embodiments, the manufacturing control system 140 may determine further specifications for the manufacture of the article of clothing based on the order line item details and recipe specification (e.g., fabric cutting specification, fabric stitching specification, placement of pockets and other features on the article of clothing).

In some embodiments, the manufacturing control system 140 may determine a manufacturing specification at least in part based on selecting a manufacturing machine 152, 154, 156 for manufacture of the article of clothing. For example, the manufacturing control system 140 may select a specific manufacturing machine 152, 154, 156 for manufacture of the article of clothing. As further example, the manufacturing control system 140 may select a specific manufacturing machine 152, 154, 156 present at a known geographic location (e.g., a screen printing machine in a specific textile workshop in Los Angeles).

In some embodiments, the manufacturing control system 140 may select the manufacturing machine 152, 154, 156 based on one or more characteristics of the manufacturing machine 152, 154, 156 and/or the user and/or the article of clothing to be manufactured. For example, the manufacturing control system 140 may select the manufacturing machine 152, 154, 156 based on a determination that the specific manufacturing machine 152, 154, 156 is capable of manufacturing the specific article of clothing identified in the product selection from the user. As further example, the manufacturing control system 140 may select the manufacturing machine 152, 154, 156 based on comparing a geographic location of the manufacturing machine 152, 154, 156 to a geographic location of the user (e.g., as identified in the user characteristic, as identified in the order line item details), and selecting the manufacturing machine 152, 154, 156 accordingly (e.g., selecting the manufacturing machine 152, 154, 156 geographically closest to the user). As further example, the manufacturing control system 140 may select the manufacturing machine 152, 154, 156 based on availability information for the manufacturing machine 152, 154, 156 received from the manufacturing system 150 and/or manufacturing machine 152, 154, 156, and selecting the manufacturing machine 152, 154, 156 accordingly (e.g., selecting the manufacturing machine 152, 154, 156 with earliest availability).

In some embodiments, the manufacturing control system 140 may determine a manufacturing format for the manufacturing machine 152, 154, 156. For example, the manufacturing control system 140 may determine a manufacturing format for the manufacturing machine 152, 154, 156 selected for manufacturing an article of clothing based on the product selection from the user. As further example, the manufacturing control system 140 may determine an input format and/or control format for controlling operation of the manufacturing machine 152, 154, 156 (e.g., ladder logic, a SOAP-based API). For instance, the manufacturing control system 140 may determine a format in which manufacturing instructions must be formatted in order for the manufacturing instructions to be machine-readable by the specific manufacturing machine 152, 154, 156 selected for manufacturing the article of clothing. In some embodiments, the manufacturing control system 140 may select more than one manufacturing machine 152, 154, 156 for manufacture of the article of clothing (e.g., the combination of a cutting machine, a stitching machine, and a sublimation printer). In such a case, the manufacturing control system 140 may determine more than one manufacturing format for the manufacturing machine 152, 154, 156.

In some embodiments, the manufacturing control system 140 may generate manufacturing instructions for manufacture of an article of clothing (e.g., as identified in the product selection) by the manufacturing machines 152, 154, 156. For example, the manufacturing control system 140 may generate the manufacturing instructions based at least in part on formatting the information contained in the manufacturing specification according to the manufacturing format determined for the specific manufacturing machines 152, 154, 156 selected for manufacture of the article of clothing.

In some embodiments, the manufacturing control system 140 may transmit the manufacturing instructions to the manufacturing system 150 and/or the manufacturing machines 152, 154, 156. For example, the manufacturing control system 140 may transmit the manufacturing instructions to the manufacturing system 150 using a web service call for a web service for which the manufacturing system is a provider of the web service. As a further example, the manufacturing control system 140 may publish the manufacturing instructions to a manufacturing queue used by the manufacturing system 150 to control operation of the manufacturing machines 152, 154, 156.

In some embodiments, the manufacturing control system 140 may transmit the manufacturing instructions in a machine-readable format. For example, the manufacturing control system 140 may transmit the manufacturing instructions in XML format, such as an XML payload in a SOAP-over-HTTP message. As further example, the manufacturing control system 140 may transmit the manufacturing instructions in JSON format, such as a JSON payload in an HTTP POST message.

In some embodiments, the manufacturing control system 140 may transmit the manufacturing instructions to the manufacturing system 150 according to a format specification. For example, the manufacturing control system 140 may transmit the manufacturing instructions based on a specification format provided by Project DXM. For instance, the manufacturing instructions may be generated according to a specification of permitted data types, data values, data formats, etc.

The manufacturing system 150 may include systems for operating a manufacturing facility, such as a facility including manufacturing machines 152, 154, and 156. For example, the manufacturing system 150 may include, at least in part, a component of an enterprise resource planning system related to managing orders for manufacture of goods. As further example, the manufacturing system 150 may include, at least in part, a system for scheduling jobs for the manufacturing machines 152, 154, 156.

In some embodiments, the manufacturing system 150 may receive the manufacturing instructions from the manufacturing control system 140. In some embodiments, the manufacturing system 150 may transmit the manufacturing instructions to the manufacturing machines 152, 154, 156. In some embodiments, the manufacturing system 150 may transmit operating instructions to the manufacturing machines 152, 154, 156 that, while not identical to the manufacturing instructions, is based at least in part on the manufacturing instructions. In some embodiments, the manufacturing control system 140 may communicate directly with the manufacturing machines 152, 154, 156. In such embodiments, the manufacturing control system 140 may receive information directly from and transmit information directly to (e.g., manufacturing instructions) the manufacturing machines 152, 154, 156. In this way, the activities described with respect to the manufacturing system 150 within this disclosure may be omitted and/or performed by the manufacturing control system 140 or the manufacturing machines 152, 154, 156. For instance, a manufacturing machine 152, 154, 156 (e.g., embroidery machine) may be capable of receiving manufacturing instructions directly from the manufacturing control system 140 or perform other communications directly with systems connected to the communications network 120 (e.g., downloading digital asset files directly from the manufacturing control system 140 over the communications network 120).

The manufacturing machines 152, 154, 156 may be machines for the manufacture of articles of clothing or other goods. For example, the manufacturing machines 152, 154, 156 may include one or more of cutting machines, sewing machines, 3D knitting machines, embroidery machines, digital printing machines, sublimation printing machines, direct to fabric printing machines, and direct to garment printing machines.

The system 100 may be provided with different configurations in various embodiments. For example, in some embodiments not all of the components just discussed are required (e.g., omitting the manufacturing system 150). As further example, in some embodiments additional components may be included. In some embodiments, components of system 100 just discussed may be combined (e.g., providing the product presentation system 130 and the manufacturing control system 140 as a single entity). In some embodiments, a components of system 100 just discussed may be divided into further components (e.g., dividing the manufacturing control system 140 into components).

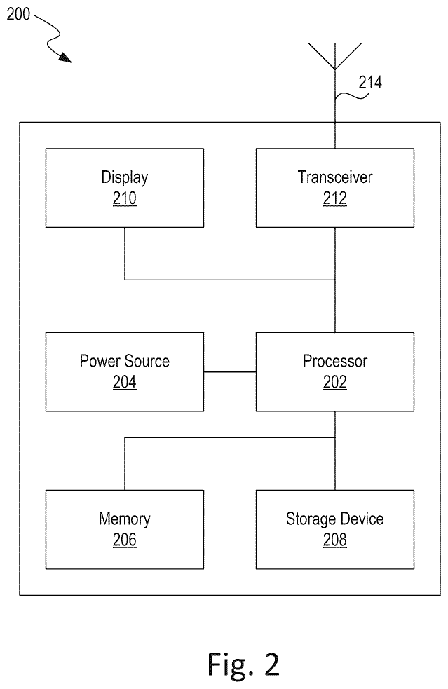

FIG. 2 is a diagram of an apparatus 200 for use in a system for manufacturing of articles of clothing or other goods. In some embodiments, apparatus 200 may be used to implement one or more aspects of a system 100, such as user equipment 102, user equipment 104, user equipment 106, communications network 120, product presentation system 130, manufacturing control system 140, manufacturing system 150, manufacturing machine 152, manufacturing machine 154, or manufacturing system 156. The apparatus 200 includes a processor 202, power source 204, memory 206, storage device 208, display 210, transceiver 212, and antenna 214.

The processor 202 may be a computer processor capable of executing instructions to perform one or more tasks described elsewhere in this disclosure. The processor 202 may be implemented as any type of known computer processor (e.g., microprocessor, central processing unit, graphics processing unit, field programmable gate array, discrete logic, wired circuitry). The processor 202 may interact with and retrieve data from memory 206 for execution of instructions by processor 202. Memory 206 may be implemented as any type of known volatile or non-volatile memory (e.g., RAM, DRAM, SRAM, Flash memory). Processor 202 may retrieve data from and store data in storage device 208. Storage device 208 may provide persistent storage of data for apparatus 200, and storage device 208 may be implemented as any type of known non-volatile memory (e.g., solid state drive, hard drive, Flash memory). The processor may send data to and receive data from transceiver 212 for transmission and reception of that data to other devices. Transceiver 212 may use antenna 214 for such transmission and reception. Transceiver 212 may be implemented as any type of known transceiver component (e.g., wired networking card, cellular modem, Wi-Fi radio). The processor may transmit data to and receive data from display 210 for presentation of data to a user and reception of user input. Display 210 may be implemented as any type of known electronic display (e.g., touchscreen, LCD, LED, OLED). Power source 204 may provide electric power for operation of the apparatus 200, including its various components such as processor 202.

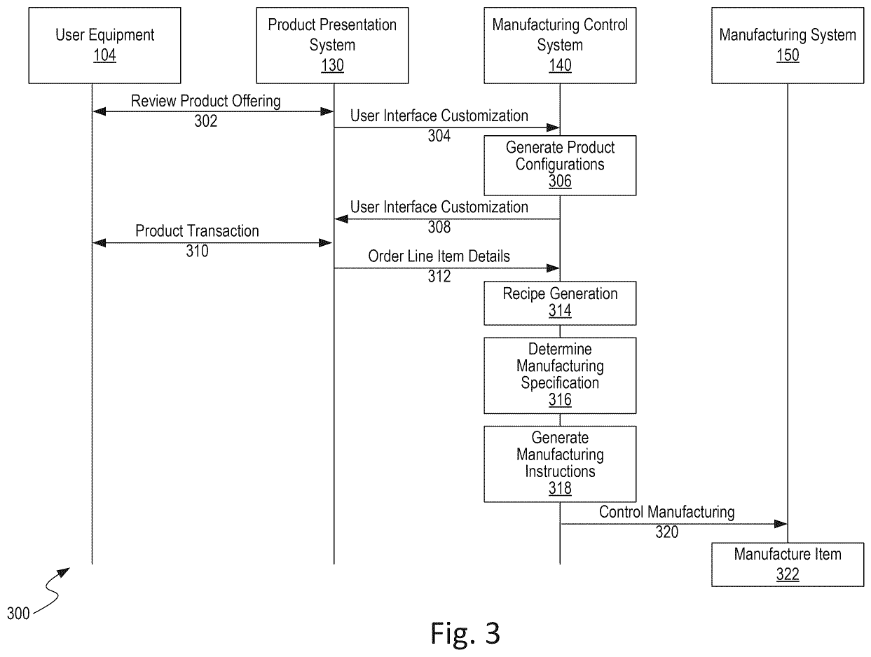

FIG. 3 is a sequence diagram of a process 300 for manufacturing of articles of clothing or other goods. The process 300 may be performed using a system for manufacturing articles of clothing or other goods, such as system 100. Exemplary embodiments of the process 300 are described with respect to components of the system 100 introduced previously.

At block 302, the user equipment 104 and the product presentation system 130 interact to allow a user to review a product offering. In some embodiments, block 302 may include presenting product information to the user on a display of user equipment 104. For example, block 302 may include a user browsing a listing of articles of clothing available to the user and selecting one or more of the articles of clothing or other items of interest to the user. Block 302 may include presenting, in response to the user selecting the article of clothing or other item of interest, a visual product rendering of the product in one or more configurations.

In some embodiments, block 302 may include the user providing user input to the user equipment 104 and the product presentation system 130. For example, the user may provide user characteristic information (e.g., user demographic information, user age, user body metrics, body scan, user avatar parameters, user weight, user height, user chest circumference, user hip circumference, user inseam, user neck circumference) and/or product characteristic information (e.g., a product of interest to the user, a category of products of interest to the user).

At block 304 the product presentation system 130 requests user interface customization from the manufacturing control system 140. In some embodiments, block 304 may include the product presentation system transmitting a user characteristic information and/or product characteristic information (e.g., as provided by the user) to the manufacturing control system 140. In some embodiments, block 304 may include the product presentation system 130 requesting from the manufacturing control system 140 product configurations for a selected product from the manufacturing control system. In some embodiments, block 304 may include the product presentation system 130 requesting from the manufacturing control system 140 a visual product rendering for a product selected by the user.

At block 306, the manufacturing control system 140 generates product configurations. In some embodiments, block 306 may include generating a plurality of product configurations for an article of clothing selected as an item of interest by the user. In some embodiments, block 306 may include generating one or more visual product renderings for a specific article of clothing or other item of interest. For example, the manufacturing control system 140 may generate a visual product rendering the represents one or more available configurations of the product that can be manufactured. The visual product rendering may be provided in various forms (e.g., two-dimensional illustration of the product, simulated three-dimensional rendering of the product, actual image of the product, video of the product). The manufacturing controls system 140 may generate the product configurations based on the user characteristic information and/or the product characteristic information input by the user at the user equipment 104.

At block 308 the manufacturing control system provides user interface customization to the product presentation 130. In some embodiments, block 308 may include the manufacturing control system transmitting a visual product rendering of an article of clothing or other item of interest selected by the user of user equipment 104. In some embodiments, the user interface customization may include a plurality of product configurations to be displayed on a display of the user equipment 104 in order to present to the user the configurations of the article of clothing that are available for manufacture (e.g., by the manufacturing system 150 and manufacturing machines 152, 154, 156).

The product presentation system 130 may use the user interface customization received at block 308 to provide user interface information to the user equipment 104 at block 302. In some embodiments, the product presentation system 130 may use product configurations received from the manufacturing control system 140 to present an interactive, simulated three-dimensional rendering of a product selected by the user of the user equipment 104. This presentation may allow the user of the user equipment 104 to more intuitively explore the available configurations of the product (e.g., an article of clothing) and to choose among the manufacturing configurations available for the product.

A block 310, the user equipment 104 and the product presentation system 130 interact to perform a product transaction. In some embodiments, block 310 may include a user of user equipment 104 selecting an article of clothing or other good for manufacture by manufacturing system 150 and manufacturing machines 152, 154, 156. As part of the product transaction of block 310, the product presentation system may receive from the user equipment 104 or otherwise retrieve or retain order line item details and/or a manufacturing recipe specification. The order line item details and manufacturing recipe specification may be provided as described elsewhere herein.

At block 312, the product presentation system 130 transmits order line item details to the manufacturing control system 140. In some embodiments, block 312 may include the product presentation system 130 transmitting the order line item details that include an identification of a user and a product that the user has selected for manufacture.

At block 314, the manufacturing control system 140 generates a manufacturing recipe specification. In some embodiments, block 314 may include the manufacturing control system generating a specification identifying manufacturing characteristics of the product that the user has selected for manufacture. For example, the manufacturing recipe specification may include an identification of a product configuration presented to the user on a display of the user equipment 104. In some embodiments, the manufacturing control system may retrieve information used to generate the manufacturing recipe specification from the product presentation system 130. In other embodiments, the manufacturing control system may retrieve information used to generate the manufacturing recipe specification from a data store maintained by the manufacturing control system 140. The manufacturing recipe specification may be provided as described elsewhere herein. The manufacturing recipe specification may identify a configuration of an article of clothing, including the configuration parameters chosen by the user of the user equipment 104 for the article of clothing (e.g., the size chosen by the user, the fit chosen by the user, measurements chosen by the user, the fabric chosen by the user, the color chosen by the user).

At block 316, the manufacturing control system 140 determines a manufacturing specification. The manufacturing specification may be provided as described elsewhere herein. In some embodiments, the manufacturing specification may specify a set of parameters defining characteristics of an article of clothing to be manufactured by the manufacturing system 150 and the manufacturing machines 152, 154, 156. In some embodiments, the manufacturing specification may identify parameters for the manufacturing process (e.g., order of steps to be taken, order of machines in a manufacturing workflow to be used).

In some embodiments, block 316 may include the manufacturing control system 140 selecting a manufacturing system 150 and/or manufacturing machine 152, 154, 156 to manufacture the article of clothing described in the manufacturing recipe specification, as described elsewhere herein. In some embodiments, the manufacturing control system may determine data parameters required for input to the selected manufacturing system 150 and/or manufacturing machine 152, 154, 156 and generate that input data as part of block 316. In some embodiments, block 316 may include generating digital assets describing the article of clothing to be manufactured, as described elsewhere herein. In some embodiments, block 316 may include generating data used to populate a technical pack, as that terminology is used in the textile manufacturing art.

At block 318, the manufacturing control system 140 generates manufacturing instructions. In some embodiments, block 318 may include generating machine-readable instructions that can be machine-process as input by the manufacturing system 150 and/or manufacturing machines 152, 154, 156. In some embodiments, block 318 may include generating the manufacturing instructions based on the data contained in the manufacturing specification and formatting that data in a format determined to be a valid input format for the manufacturing system 150 and/or manufacturing machines 152, 154, 156. In some embodiments, block 318 may include generating the manufacturing instructions based on the data contained in the manufacturing specification and formatting that data according to a specification format provided by Project DXM. In some embodiments, block 318 may include formatting the data contained in the manufacturing specification according to a data representation format, such as XML or JSON.

At block 320, the manufacturing control system 140 controls manufacturing of an article of clothing by manufacturing system 150. In some embodiments, block 320 may include the manufacturing control system 140 transmitting machine-readable manufacturing instructions to the manufacturing system 150 and/or manufacturing machines 152, 154, 156. In some embodiments, block 320 may include the manufacturing control system 140 transmitting the manufacturing instructions to a microcontroller integrated with the manufacturing machines 152, 154, 156. In such embodiments, the microcontroller may be configured to receive the manufacturing instructions over the communications network 120 and control physical operation of the manufacturing machines 152, 154, 156 according to the received manufacturing instructions.

At block 322, the manufacturing system 150 manufactures the article of clothing. In some embodiments, block 322 includes operating the manufacturing system 150 and/or manufacturing machines 152, 154, 156 in order to manufacture the article of clothing or other good according to the manufacturing specification.

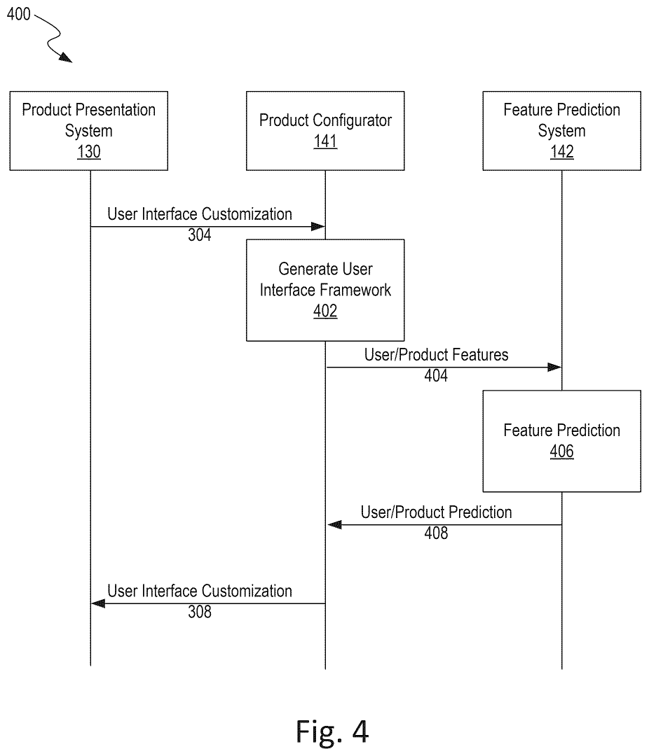

FIG. 4 is a sequence diagram of a process 400 for manufacturing of articles of clothing or other goods. The process 400 may be performed using a system for manufacturing articles of clothing or other goods, such as system 100. Exemplary embodiments of the process 400 are described with respect to components of the system 100 introduced previously.

Process 400 may include activities performed by a product configurator 141 and a feature prediction system 142. In some embodiments, the product configurator 141 and the feature prediction system 142 may be provided as part of the system 100. In some embodiments, the product configurator 141 and the feature prediction system 142 may be subsystems, components, or other subordinate units of the manufacturing control system 140. In some embodiments, the product configurator 141 and the feature prediction system 142 may be independent system from the manufacturing control system 140, and the manufacturing control system 140 may invoke the product configurator 141 and the feature prediction system 142 for the activities described herein.

In some embodiments, process 400 may be provided as an implementation of, an alternative embodiment to, or otherwise integrated with the process 300. For example, user interface customization at block 304 and user interface customization at block 308 may be performed substantially as described with respect to the process 300. As further example, blocks 402, 404, 406, and 408 of process 400 may provide an implementation of the activity described with respect to block 306 of process 300.

At block 402, the product configurator generates a user interface framework. In some embodiments, block 142 may include generating a visual rendering interface framework for presenting a visual representation to the user via the user equipment 104 and/or the product presentation system 130. For example, block 142 may include generating an applet, an embedded media player, an HTML5 session, a media streaming session, or the like for presentation of visual and/or audio content on the user equipment 104 and/or product presentation system 130. The user interface framework may provide a GUI interface through which a user of the user equipment 104 may interact with a visual product rendering, such as a simulated three-dimensional rendering of a product selected by the user. The user interface framework may include a display region, a key for displayed information, and/or a user manipulable control panel for alteration of the visual product rendering.

At block 404, the product configurator 141 transmits user features and/or product features to the feature prediction system 142. In some embodiments, the product configurator 141 may transmit user characteristic information and/or product characteristic information received from the user via the user equipment 104 and/or product presentation system 130.

At block 406, the feature prediction system 142 predicts features. The feature prediction system 142 may predict features based on the user characteristic information and/or product characteristic information provided at block 404.

In some embodiments, the feature prediction system 142 may predict features of the user based on the provided user characteristic information. For example, the feature prediction system 142 may predict a set of body features of the user based on the provided user characteristic information. For example, based on user characteristic information including the user's height, the user's weight, the user's gender, the user's chest measurement, and the user's hip measurement, the feature prediction system 142 may predict body measurement for the user, such as inseam, arm length, neck circumference, waist circumference, and other user measurements relevant to the fit of an article of clothing to the user's body.

In some embodiments, the feature prediction system 142 may predict features of a product based on the provided user characteristic information and the product characteristic information. For example, the feature prediction system 142 may predict a best clothing for the user based on the provided user characteristic information and the product characteristic information. For example, based on user characteristic information including the user's height, the user's weight, the user's gender, the user's chest measurement, and the user's hip measurement and based on product characteristic information including an identification of a specific article of clothing, the feature prediction system 142 may predict a best size (e.g., small, medium, large) and/or a best fit (e.g., regular fit, slim fit, tapered leg) of the specific article of clothing to fit the user's body. In some embodiments, instead of predicting a single best size, best fit, etc., the feature prediction system 142 may predict a ranking of suitable sizes, fits, etc. for the article of clothing for the user's body. In some embodiments, instead of the product characteristic information identifying a specific article of clothing, the product characteristic information may identify a specific category of clothing. In such embodiments, the feature prediction system 142 may predict and/or rank suitable specific articles of clothing to fit the user's body.

Various other predictions of user features and/or product features are possible with other embodiments of the disclosure.

At block 408, the feature prediction system 142 transmits user feature predictions and/or product feature predictions to the product configurator 141. In some embodiments, block 408 may include the feature prediction system 142 transmitting to the product configurator 141 the user feature predictions, user feature rankings, product feature predictions, product feature rankings, etc. generated by the feature prediction system 142 at block 406.

In some embodiments, the product configurator 141 may subsequently perform further activities to generate product configurations, such as described with respect to block 306 of process 300.

In some embodiments, the product configurator 141 and/or feature prediction system 142 may not communicate directly with the product presentation system 130. In such embodiments, the manufacturing control system 140 may intermediate communications between the product presentation system 130 and the product configurator 141 and/or feature prediction system 142.

In some embodiments, the product configurator 141 may not communicate directly with the feature prediction system 142. In such embodiments, the manufacturing control system 140 may intermediate communications between the product configurator 141 and the feature prediction system 142.

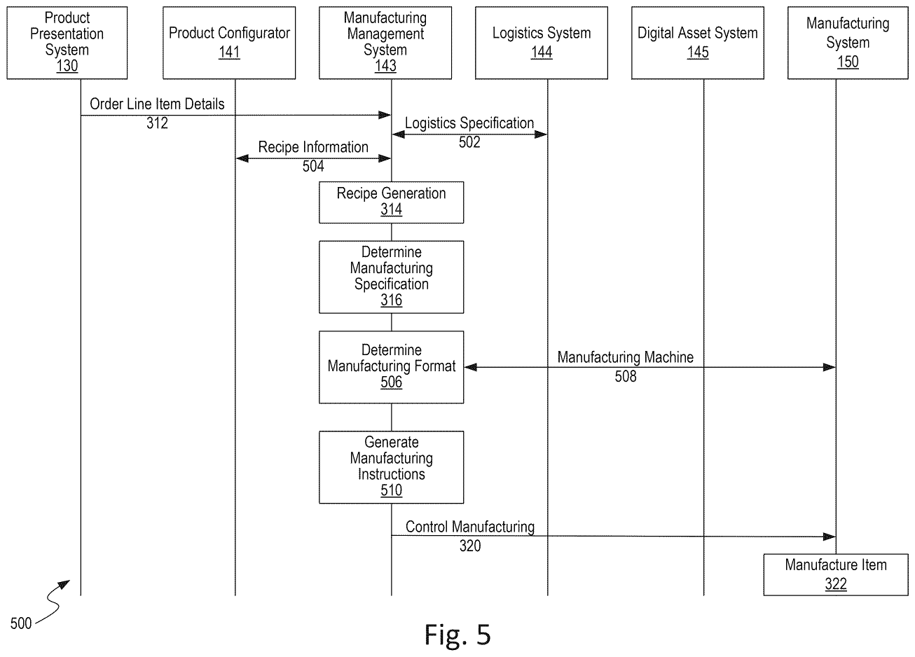

FIG. 5 is a sequence diagram of a process 500 for manufacturing of articles of clothing or other goods. The process 500 may be performed using a system for manufacturing articles of clothing or other goods, such as system 100. Exemplary embodiments of the process 500 are described with respect to components of the system 100 introduced previously.

Process 500 may include activities performed by a product configurator 141, a manufacturing management system 143, and a logistics system 144. In some embodiments, the product configurator 141, the manufacturing management system 143, and the logistics system 144 may be provided as part of the system 100. In some embodiments, the product configurator 141, the manufacturing management system 143, and the logistics system 144 may be subsystems, components, or other subordinate units of the manufacturing control system 140. In some embodiments, the product configurator 141, the manufacturing management system 143, and the logistics system 144 may be independent systems from the manufacturing control system 140, and the manufacturing control system 140 may invoke the product configurator 141, the manufacturing management system 143, and the logistics system 144 for the activities described herein.

In some embodiments, process 500 may be provided as an implementation of, an alternative embodiment to, or otherwise integrated with the process 300. For example, order line item details at block 312, recipe generation at block 314, determining the manufacturing specification at block 316, controlling manufacturing at block 320, and manufacturing an item at block 322 may be performed substantially as described with respect to the process 300. As further example, blocks 502 and 504 of process 500 may be performed in addition to the activities described with respect to process 300. As further example, blocks 506, 508, and 510 of process 500 may provide an implementation of the activity described with respect to block 318 of process 300.

At block 502, the manufacturing management system 143 communicates with the logistics system 144 to generate a logistics specification. In some embodiments, the logistics specification may include information describing a physical delivery of a manufactured item (e.g., the item to be manufactured at block 322) to the user of the user equipment 104. In some embodiments, the logistics system 144 provides shipping and other logistics information for using third-party shipping and logistics companies to deliver physical goods. In some embodiments, the manufacturing management system 143 may generate a logistics specification to include geographic location information for the user of the user equipment 104 (e.g., residential address, mailing address, business address), such as by receiving such information as part of the user characteristic information from the user. In some embodiments, the manufacturing management system 143 may generate a logistics specification to include geographic location information for the manufacturing machines 152, 154, 156, such as an identification of a physical location where the manufacturing machines 152, 154, 156 are located.

At block 504, the manufacturing management system 143 communicates with the product configurator 141 to obtain manufacturing recipe specification information. In some embodiments, the product configurator 141 may store manufacturing recipe information, such as product features of an article of clothing that the user of user equipment 104 chose before performing the product transaction of block 310 of process 300. The manufacturing management system 143 may obtain from the product configurator 141 such information describing features selected by the user in the visual product rendering provided by the product configurator 141 to the product presentation system 130 and/or the user equipment 104 (e.g., a selected product color, a selected product stitching style, a selected product fabric, a selected product fit, selected product measurements).

At block 314, the manufacturing management system 143 generates a manufacturing recipe specification, such as described previously with respect to block 314 of process 300. In some embodiments, in addition to the activity described previously with respect to block 314 of process 300, the manufacturing management system 143 may at block 314 use the manufacturing recipe specification information obtained from the product configurator at block 141.

At block 316, the manufacturing management system 143 determines a manufacturing specification, such as described previously with respect to block 316 of process 300. In some embodiments, in addition to the activity described previously with respect to block 316 of process 300, the manufacturing management system 143 may at block 316 use the logistics specification generated at block 502 in order to determine the manufacturing specification at block 316.

At block 506, the manufacturing management system 506 determines a manufacturing format. In some embodiments, the manufacturing management system 143 may determine a manufacturing format for the manufacturing machine 152, 154, 156 as described previously with respect to the manufacturing control system 140.

At block 508, the manufacturing management system 143 communicates with the manufacturing system 150 to obtain manufacturing machine information. In some embodiments, the manufacturing machine information may include information describing characteristics of the manufacturing machines 152, 154, 156, such as the geographic location of the manufacturing machines 152, 154, 156, the functionality of the manufacturing machines 152, 154, 156 (e.g., cutter, stitcher, printer), the input data format of the manufacturing machines 152, 154, 156, or the like. The manufacturing management system 506 may use the manufacturing machine information obtained at block 508 to determine the manufacturing format at block 506. In some embodiments, the manufacturing management system 506 may use the manufacturing machine information obtained at block 508 to select, at block 316, one or more manufacturing machines 152, 154, 156 for manufacture of the article of clothing or other item at block 322.

At block 510, the manufacturing management system 143 generates manufacturing instructions. The manufacturing management system 143 may use the manufacturing format determined at block 506 to format the manufacturing specification information determined at block 316. The manufacturing management system 143 may format the manufacturing specification in a format that is machine-readable by the manufacturing system 150 and/or the manufacturing machines 152, 154, 156. The manufacturing management system 143 may, at block 510, generate manufacturing instructions as described elsewhere with respect to block 318 of process 300 and as described elsewhere herein.

At block 320, the manufacturing management system 143 controls manufacturing, such as described previously with respect to block 320 of process 300.

At block 322, the manufacturing system 150 manufactures an item, such as described previously with respect to block 322 of process 300.

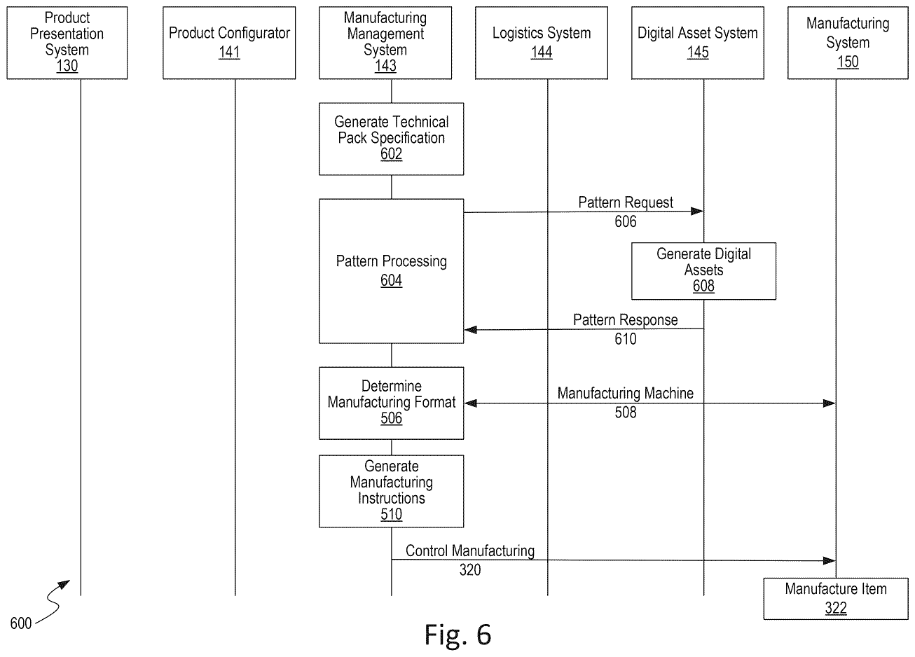

FIG. 6 is a sequence diagram of a process 600 for manufacturing of articles of clothing or other goods. The process 600 may be performed using a system for manufacturing articles of clothing or other goods, such as system 100. Exemplary embodiments of the process 600 are described with respect to components of the system 100 introduced previously.

Process 600 may include activities performed by manufacturing management system 143 and a digital asset system 145. In some embodiments, the manufacturing management system 143 and the digital asset system 145 may be provided as part of the system 100. In some embodiments, the manufacturing management system 143 and the digital asset system 145 may be subsystems, components, or other subordinate units of the manufacturing control system 140. In some embodiments, the manufacturing management system 143 and the digital asset system 145 may be independent systems from the manufacturing control system 140, and the manufacturing control system 140 may invoke the manufacturing management system 143 and the digital asset system 145 for the activities described herein.

In some embodiments, process 600 may be provided as an implementation of, an alternative embodiment to, or otherwise integrated with the process 300 and/or the process 300 as further elaborated with the disclosure of FIG. 500. For example, determining manufacturing format at block 506, obtaining manufacturing machine information at block 508, generating manufacturing instructions at block 510, controlling manufacturing at block 320, an manufacturing an item at block 322 may be performed substantially as described with respect to the process 300 and process 500. As further example, blocks 602, 604, 606, 608, and 610 of process 600 may provide an implementation of the activity described with respect to determining a manufacturing specification at block 316 of process 300 and process 500.

At block 602, the manufacturing management system 143 generates technical pack specification information. In some embodiments, the manufacturing management system 143 may generate the technical pack specification information that would typically be included in a technical pack, as that terminology is used in the textile manufacturing art. The manufacturing management system 143 may generate the technical pack specification information based at least in part on the manufacturing recipe specification generated at block 314 of process 300, as well as other information stored by the manufacturing management system 143.

In some embodiments, at block 602, the manufacturing management system 143 may generate additional technical pack specification information describing the manufacture of an article of clothing by the manufacturing system 150 and/or the manufacturing machines 152, 154, 156, such as: the types of seams to be included in the article of clothing; the types of stitches to be used during manufacture of the article of clothing; the style of pocket to be used on the article of clothing; the gauge of the needle to be used during the manufacture of the article of clothing; the type of fabric to be used to manufacture the article of clothing; reinforcements and other textile structural features to be used for the article of clothing; specific International Organization of Standards specifications to be used for the manufacture of the article of clothing; style of folding to be performed for the article of clothing after manufacture; type and location of label to be placed on the article of clothing; specific fabric measurements to be used for specific sizes of the article of clothing (e.g., upper arm-at armhole, sleeve length, sweep, hem height, pocket placement); material composition of the article of clothing (e.g., cotton, polyester, heather fabric); type of packaging to be used for the article of clothing after manufacture, etc.

In some embodiments, at block 602, the

At block 604, the manufacturing management system 143 performs pattern processing. The manufacturing management system 143 may generate a description of a pattern to be used during manufacture of the article of clothing at block 322. In some embodiments, the manufacturing management system 143 may determine manufacturing characteristics used to manufacture the article of clothing according to the user customizations selected by the user and reflected in the manufacturing recipe specification. For example, the manufacturing management system 143 may determine a type of material to use during manufacture, a color of material to use during manufacture, a texture of material to use during manufacture, etc.

At block 606, the manufacturing management system 143 transmits a pattern request to the digital asset system 145. In some embodiments the manufacturing management system 143 may transmit one or more elements of information from the manufacturing recipe specification generated at block 314, size data, fit data, identification of the manufacturing system 150 and/or manufacturing machines 152, 154, 156, and/or information from the technical pack specification information.

At block 608, the digital asset system 145 generates digital assets. The digital asset system 145 may generate digital assets describing a pattern or other feature for manufacture of the article of clothing at block 322. For example, the digital asset system 145 may include a visual pattern rendering and/or a machine-readable descriptor file for the pattern information received at block 606. In some embodiments, the digital asset system 145 may generate a machine-readable descriptor file indicating a printing operation to be performed on the article of clothing during manufacture at block 322. In some embodiments, the digital asset system 145 may generate a machine-readable descriptor file indicating a cutting operation to be performed on the article of clothing during manufacture at block 322. In some embodiments, the digital asset system 145 may generate a machine-readable descriptor file indicating a stitching operation to be performed on the article of clothing during manufacture at block 322. In some embodiments, the digital asset system 145 may generate a machine-readable descriptor file indicating a dying operation to be performed on the article of clothing during manufacture at block 322.

At block 610, the manufacturing management system 143 receives a pattern response from the digital asset system 145. The digital asset system 145 may transmit to the manufacturing management system 143 the digital assets generated at block 608.

At block 506, the manufacturing management system 143 determines a manufacturing format, such as described previously with respect to block 506 of process 500.

At block 510, the manufacturing management system 143 generates manufacturing instructions, such as described previously with respect to block 510 of process 500.

At block 320, the manufacturing management system 143 controls manufacturing, such as described previously with respect to block 320 of process 300.

At block 322, the manufacturing system 150 manufactures an item, such as described previously with respect to block 322 of process 300.

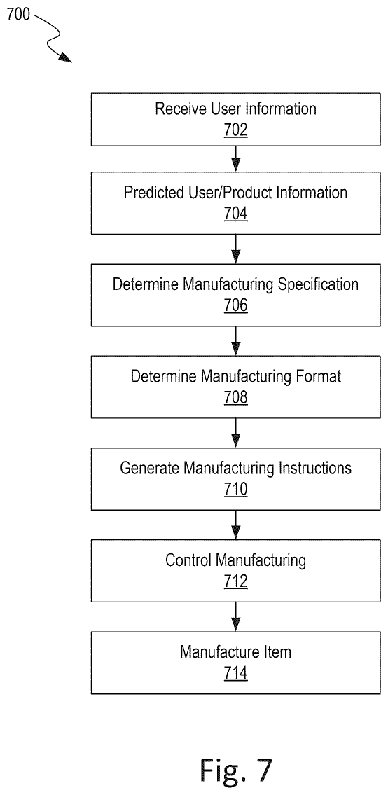

FIG. 7 is a flowchart diagram of a process 700 for manufacturing of articles of clothing or other goods. The process 700 may be performed using a system for manufacturing articles of clothing or other goods, such as system 100. Exemplary embodiments of the process 700 are described with respect to components of the system 100 introduced previously.

At block 702, user information is received. For example, a user equipment 104 and/or product presentation system 130 may receive user characteristic information and/or product characteristic information from a user.

At block 704, user information and/or product information is predicted. For example, a feature prediction system 142 may predict a user feature (e.g., body measurements) and/or a product feature (e.g., a best fit of a specific article of clothing for a specific user).

At block 706, a manufacturing specification is determined. For example, a manufacturing control system 140 and/or a manufacturing management system 143 may determine a manufacturing specification, such as a manufacturing machine 152, 154, 156 to use for manufacture, a fabric to use, a size to manufacture, etc. The manufacturing control system 140 and/or a manufacturing management system 143 may determine the manufacturing specification based on order line item details and/or a manufacturing recipe specification.

At block 708, a manufacturing format is determined. For example, a manufacturing control system 140 and/or a manufacturing management system 143 may determine a machine-readable input format for the manufacturing system 150 and/or manufacturing machines 152, 154, 156.

At block 710, manufacturing instructions are generated. For example, a manufacturing control system 140 and/or a manufacturing management system 143 may generate manufacturing instructions for controlling operation of the manufacturing system 150 and/or manufacturing machines 152, 154, 156 in order to manufacture an article of clothing. In some embodiments, the manufacturing control system 140 and/or the manufacturing management system 143 may generate the manufacturing instructions by formatting the manufacturing specification determine at block 706 according to the manufacturing format determined at block 708.

At block 712, manufacturing is controlled. For example, a manufacturing control system 140 and/or a manufacturing management system 143 may control manufacture of an article of clothing by the manufacturing system 150 and/or manufacturing machines 152, 154, 156. The manufacturing control system 140 and/or the manufacturing management system 143 may control manufacture of an article of clothing by the manufacturing system 150 and/or manufacturing machines 152, 154, 156 at least in part based on transmitting the manufacturing instructions generated at block 710 to the manufacturing system 150 and/or manufacturing machines 152, 154, 156.

At block 714, an item is manufactured. For example, an article of clothing may be manufactured by the manufacturing system 150 and/or manufacturing machines 152, 154, 156 based on operating of the manufacturing machines 152, 154, 156 according to the manufacturing instructions transmitted at block 712.

While the present disclosure has presented exemplary embodiments related to the clothing manufacturing industry, the features disclosed herein are applicable to additional industries as well. For example, embodiments may be implemented for the manufacture of other goods for which user-specific customizations are desired, such as shoes, bags, hats, watches, socks, signage, jewelry, furniture, and personal electronics.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only some implementations and examples are described herein, and other implementations, enhancements, and variations can be made based on what is described and illustrated in this patent document.

What is claimed is:

1. A system comprising:
a user equipment configured to receive user input including user characteristic information and product characteristic information;
a product presentation system configured to present product configurations to the user, wherein the product presentation system is further configured to receive a product selection from the user equipment, wherein the product selection comprises order line item details and a recipe specification;
a manufacturing control system configured to provide, based on the user characteristic information and the product characteristic information, the product configurations to the product presentation system, wherein the manufacturing control system is configured to retrieve the order line item details and the recipe specification from the product presentation system, wherein the manufacturing control system is configured to determine a manufacturing specification for manufacture of an article corresponding to the product selection, wherein the manufacturing control system is configured to determine a manufacturing format for one or more manufacturing machines, wherein the manufacturing control system is configured to generate manufacturing instructions based on the manufacturing specification and the manufacturing format, wherein the manufacturing control system is configured to transmit the manufacturing instructions to a manufacturing system; and
the manufacturing system configured to receive the manufacturing instructions from the manufacturing control system, wherein the manufacturing system is configured to provide the manufacturing instructions to the one or more manufacturing machines; and
the one or more manufacturing machines configured to manufacture the article corresponding to the product selection based on the manufacturing instructions.

2. The system of claim 1, further comprising:
a feature prediction system configured to predict one or more predicted features based at least in part on the user characteristic information or product characteristic information, a product configurator system configured to generate customized product configuration information based at least in part on the user characteristic information or product characteristic information and further based at least in part on the predicted features, wherein the product presentation system is configured to present the product configurations to the user based at least in part on the customized product configuration information.

3. The system of claim 2, further comprising:
a digital asset system configured to generate one or more manufacturing digital assets for manufacture of the article, wherein the digital asset system is configured to receive the recipe specification from the manufacturing control system, wherein the digital asset system is configured to generate the one or more manufacturing digital assets based at least in part on the recipe specification, wherein the manufacturing control system is configured to determine the manufacturing specification based at least in part on the manufacturing digital assets.

4. The system of claim 3, further comprising:
a logistics system configured to cause the physical transport of the manufactured article from the one or more manufacturing machines to the user, wherein the manufacturing control system is configured to select the one or more manufacturing machines for manufacture of the article based at least in part on a logistics specification provided by the logistics system.

5. The system of claim 4, wherein the manufacturing control system is configured to generate the manufacturing instructions in a format that is machine-readable by the one or more manufacturing machines configured to manufacture the article corresponding to the product selection.

6. A method comprising:
receiving user input including user characteristic information and product characteristic information;
presenting product configurations to the user;
receiving a product selection from the user, wherein the product selection comprises order line item details and a recipe specification;
providing, based on the user characteristic information and the product characteristic information, the product configurations;
retrieving the order line item details and the recipe specification;
determining a manufacturing specification for manufacture of an article corresponding to the product selection;
determining a manufacturing format for one or more manufacturing machines,
generating manufacturing instructions based on the manufacturing specification and the manufacturing format,
transmit the manufacturing instructions to a manufacturing system; and
receiving, by the manufacturing system, the manufacturing instructions,
providing the manufacturing instructions by the manufacturing system to the one or more manufacturing machines; and
manufacturing by the one or more manufacturing machines the article corresponding to the product selection based on the manufacturing instructions.

7. The method of claim 6, further comprising:
predicting one or more predicted features based at least in part on the user characteristic information or product characteristic information;
generating customized product configuration information based at least in part on the user characteristic information or product characteristic information and further based at least in part on the predicted features; and
wherein presenting the product configurations to the user is based at least in part on the customized product configuration information.

8. The method of claim 7, further comprising:
generating one or more manufacturing digital assets for manufacture of the article;
receiving the recipe specification from the manufacturing control system;
generating the one or more manufacturing digital assets based at least in part on the recipe specification; and
wherein determining the manufacturing specification is based at least in part on the manufacturing digital assets.

9. The method of claim 7, further comprising:
causing the physical transport of the manufactured article from the one or more manufacturing machines to the user; and
selecting the one or more manufacturing machines for manufacture of the article based at least in part on a logistics specification provided by the logistics system.

10. The method of claim 9, wherein the manufacturing instructions are generated in a format that is machine-readable by the one or more manufacturing machines configured to manufacture the article corresponding to the product selection.

11. A system comprising:
a user equipment configured to receive user input including user characteristic information and product characteristic information, wherein the user characteristic information includes at least one of a plurality of body metrics for the user, a body scan for the user, or user avatar parameters for the user, wherein the product characteristic information includes product identifying information for an item of interest for the user;
a product presentation system configured to present product configurations to the user, wherein the product presentation system is further configured to receive a product selection from the user equipment, wherein the product selection comprises order line item details and a recipe specification, wherein the order line item details include order identifying information, wherein the recipe specification includes identification of a clothing product and one or more of clothing size information or clothing fit information;
a manufacturing control system configured to provide, based on the user characteristic information and the product characteristic information, the product configurations to the product presentation system, wherein the product configurations include one or more configuration for a clothing product corresponding to the item of interest for the user, wherein the manufacturing control system is configured to retrieve the order line item details and the recipe specification from the product presentation system, wherein the manufacturing control system is configured to determine a manufacturing specification for manufacture of an article of clothing corresponding to the product selection, wherein the manufacturing control system is configured to determine a manufacturing format for one or more manufacturing machines, wherein the manufacturing control system is configured to generate manufacturing instructions based on the manufacturing specification and the manufacturing format, wherein the manufacturing control system is configured to transmit the manufacturing instructions to a manufacturing system; and
the manufacturing system configured to receive the manufacturing instructions from the manufacturing control system, wherein the manufacturing system is configured to provide the manufacturing instructions to the one or more manufacturing machines; and
the one or more manufacturing machines configured to manufacture the article of clothing corresponding to the product selection based on the manufacturing instructions.

12. The system of claim 11, further comprising:
a feature prediction system configured to predict one or more predicted features based at least in part on the user characteristic information or product characteristic information, wherein the one or more predicted features includes one or more predicted body measurements of the user predicted based at least in part on the plurality of body metrics for the user, the body scan for the user, or the user avatar parameters for the user;
a product configurator system configured to generate customized product configuration information based at least in part on the user characteristic information or product characteristic information and further based at least in part on the predicted features, wherein the customized product configuration information includes a visual product rendering of a clothing product corresponding to the item of interest for the user generated based at least in part on the one or more predicted body measurements of the user, wherein the product presentation system is configured to present the product configurations to the user based at least in part on the customized product configuration information.

13. The system of claim 12, further comprising:
a digital asset system configured to generate one or more manufacturing digital assets for manufacture of the article of clothing, wherein the one or more manufacturing digital assets includes one or more of technical pack information or textile pattern images, wherein the digital asset system is configured to receive the recipe specification from the manufacturing control system, wherein the digital asset system is configured to generate the one or more manufacturing digital assets based at least in part on the recipe specification, wherein the manufacturing control system is configured to determine the manufacturing specification based at least in part on the manufacturing digital assets.

14. The system of claim 13, further comprising:
a logistics system configured to cause the physical transport of the manufactured article of clothing from the one or more manufacturing machines to the user, wherein the manufacturing control system is configured to select the one or more manufacturing machines for manufacture of the article of clothing based at least in part on a logistics specification provided by the logistics system, wherein the manufacturing control system is configured to select the one or more manufacturing machines for manufacture of the article of clothing based at least in part on a comparison of manufacturing geographic location information provided in the logistics specification with a user geographic location information for the user.

15. The system of claim 14, wherein the manufacturing control system is configured to generate the manufacturing instructions in a format that is machine-readable by the one or more manufacturing machines configured to manufacture the article of clothing corresponding to the product selection.

16. The system of claim 15, wherein the visual product rendering of the clothing product includes a simulated three-dimensional rendering of an article of clothing with dimensions of the article of clothing adjusted to correspond to the one or more predicted body measurements of the user.

17. The system of claim 16, wherein the manufacturing instructions includes one or more of pattern information or stitching information.

18. The system of claim 17, wherein the one or more manufacturing machines includes one or more of a cutting machine, a sewing machine, an embroidery machine, or a fabric printer.

19. The system of claim 18, wherein the manufacturing instructions identify a manufacturing work order for less than ten articles of the article of clothing.

20. The system of claim 19, wherein the manufacturing instructions identify a manufacturing work order for one article of the article of clothing.
